(19) United States
(12) Patent Application Publication
(10) Pub. No.: US 2006/0094412 A1
(43) Pub. Date: May 4, 2006

(54) System and method for restricting functionality of a mobile device

(76) Inventors: Yoko Nonoyama, Kanagawa-ken (JP); Toshiaki Yamauchi, Tokyo (JP)

Correspondence Address: MOTOROLA INC, 600 NORTH US HIGHWAY 45, ROOM AS437, LIBERTYVILLE, IL, 60048-5343, US

(21) Appl. No.: 10/977,109

(22) Filed: Oct. 29, 2004

(51) Int. Cl. H04M 3/00

(52) U.S. Cl. 455/418

(57) ABSTRACT

There is provided a mobile device (102) comprising a wireless communication transceiver (202), a radio frequency identification reader (228) and a processor (204) configured to manage operation of the wireless communication transceiver (202) and the radio frequency identification reader (228), and a method thereof. The wireless communication transceiver (202) is configured to communicate with a remote wireless station (104, 106). The radio frequency identification reader (228) is configured to transmit an outgoing electromagnetic wave signal to a radio frequency identification tag (128, 230) and receive an incoming electromagnetic wave signal in response to the outgoing electromagnetic wave signal. The incoming electromagnetic wave signal includes an identification number associated with the radio frequency identification tag. The processor (204) restricts operation of a function associated with the incoming electromagnetic wave signal in response to determining that the radio frequency identification reader has received the incoming electromagnetic wave signal.

### FIELD OF THE INVENTION

The present invention relates generally to the field of wireless communication systems, networks and devices. More particularly, the present invention relates to mobile devices, and the methods thereof, that benefit from use of Radio Frequency Identification (RFID) technology.

### BACKGROUND OF THE INVENTION

Wireless communication networks enable network connectivity of mobile devices. However, restricted use of mobile devices may be appropriate in certain locations and/or situations. A digital camera of a mobile device might be used inappropriately to perform digital shoplifting of book and magazine content in a book store. A transceiver of a mobile device may emit radio frequency signals inappropriately near medical equipment in a hospital and cause them to malfunction. Call alerts and general operation of a mobile device might disturb people situated near the mobile device at public forums, such as theaters and libraries.

Certain types of systems and methods for restricting operation of a mobile device are known. Such types of systems and methods including a base station installed near a place where use of a mobile device is restricted. U.S. Pat. No. 6,085,096, issued on Jul. 4, 2000, discloses a system in which the base station transmits a signal to the mobile device, instructing the mobile device to turn off its power supply, when the mobile device enters an area covered by the base station. Similarly, U.S. Pat. No. 6,438,385 issued Aug. 20, 2002, discloses a method in which the mobile device that mutes itself in response to receiving predetermined message from the base station. Accordingly, existing systems and methods require a powerful transponder, such as a base station, to transmit signals to mobile devices to disable operation of the mobile devices.

Radio Frequency Identification (RFID) systems use radio technology to remotely read data from a transponder, known as an RF tag or simply a tag. An RFID system typically includes an RFID reader, a reader antenna, and a tag which also comprises a tag antenna. An RFID reader is sometimes combined with a decoder and is referred to as an interrogator.

RFID systems have become widespread because of their usefulness for information collection and tracking and many applications have emerged. If the beneficial aspects of RFID data collection systems could be made use of for mobile device communication, the problems associated with data collection, particularly data useful for accessing or launching applications on a mobile device, may be eliminated. Therefore a need exists for an apparatus and method which combines the operational capabilities of a mobile device with the communication capabilities of an RFID system to restrict operation of the mobile device at inappropriate locations and/or situations.

### BRIEF DESCRIPTION OF THE DRAWINGS

FIG. 1 is a block diagram illustrating a network infrastructure in which a mobile device may operate in accordance with the present invention

FIG. 2 is a block diagram illustrating exemplary components of the mobile device in accordance with the present invention.

FIG. 3 is block diagram illustrating a first embodiment of the mobile device receiving RFID information from commercial goods.

FIG. 4 is a block diagram illustrating a second embodiment of the mobile device receiving RFID information from medical equipment.

FIG. 5 is a block diagram illustrating a third embodiment of the mobile device receiving RFID information from entertainment venue seats.

FIG. 6 is a flow diagram of an exemplary operation of the mobile device in accordance with the present invention.

### DETAILED DESCRIPTION OF THE PREFERRED EMBODIMENTS

One aspect of the present invention is a mobile device comprising a wireless communication transceiver, a radio frequency identification reader and a processor configured to manage operation of the wireless communication transceiver and the radio frequency identification reader. The wireless communication transceiver is configured to communicate with a remote wireless station. The radio frequency identification reader is configured to transmit an outgoing electromagnetic wave signal to a radio frequency identification tag and receive an incoming electromagnetic wave signal in response to the outgoing electromagnetic wave signal. The incoming electromagnetic wave signal includes an identification number associated with the radio frequency identification tag. The processor restricts operation of a function associated with the incoming electromagnetic wave signal in response to determining that the radio frequency identification reader has received the incoming electromagnetic wave signal.

Another aspect of the present invention is a method of a mobile device having a wireless communication transceiver and a radio frequency identification reader. The radio frequency identification reader transmits an outgoing electromagnetic wave signal to a radio frequency identification tag. The radio frequency identification reader then receives an incoming electromagnetic wave signal from the radio frequency identification tag in response to the outgoing electromagnetic wave signal. The incoming electromagnetic wave signal includes an identification number associated with the radio frequency identification tag. Thereafter, the mobile device restricts operation of a function associated with the incoming electromagnetic wave signal in response to determining that the radio frequency identification reader has received the incoming electromagnetic wave signal.

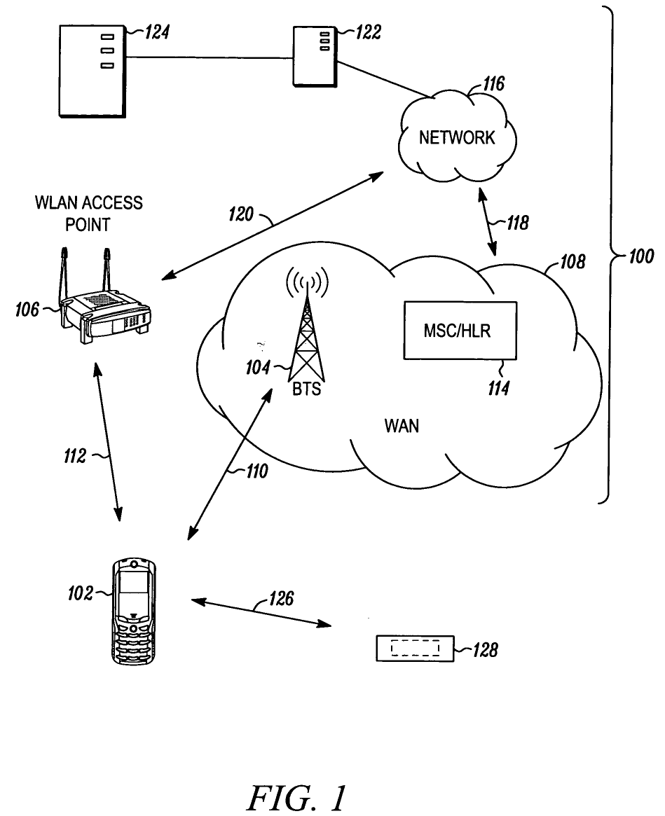

Turning now to the drawings wherein like numerals represent like components, FIG. 1 is a block diagram illustrating a network infrastructure 100 in which a mobile device 102 may operate in accordance with the present invention. In FIG. 1, the mobile device 102 is capable of communicating with one or more remote wireless stations 104, 106. The mobile device 102 may communicate with a cellular network 108 via a cellular base station 104 and a cellular communication link 110 and/or communicate with a Wireless Local Area Network (WLAN) via a WLAN Access point (AP) 106 and a WLAN communication link 112.

Wireless communication links, such as cellular communication link 110 and WLAN communication link 112, utilized by the network infrastructure 100 include, but are not limited to, cellular-based communications such as analog communications (using AMPS), digital communications (using CDMA, TDMA, GSM, iDEN, GPRS, or EDGE), and next generation communications (using UMTS, WCDMA or CDMA2000) and their variants; a peer-to-peer or ad hoc communications such as HomeRF, Bluetooth and IEEE 802.11 (a, b or g); and other forms of wireless communication such as infrared technology.

The cellular network 108 is a wide area network (WAN) and includes various components such as the cellular base station or Base Transceiver Station (BTS) 104 and a Mobile Switching Center (MSC) 114 which may also include, or operate in conjunction with, a Home Location Register (HLR). It is to be understood that the cellular network 108 as shown in FIG. 1 is for illustrative purposes only, and that the network may comprise a number of BTS's, MSC's, HLR's, as well as other components not specifically mentioned herein. The cellular network 108 may also communicate with other networks such as network 116, which may be the Internet, via connectivity 118. Similarly, the WLAN network may communicate with the network 116 by the WLAN AP 106 via connectivity 120. The network 116 may include, or cooperate with, a number of other networks or servers, such as a radio frequency identification (RFID) server 122 and/or an application server 124.

The mobile device 102 includes an RFID component that is capable of transmitting and receiving signals over an RFID air interface 126, to read data from an RFID tag 128. After reading the information provided by the RFID tag 128, the mobile device 102 uses the information to restrict one or more of its functions and may, optionally, use the information to access the RFID server 122 and/or the application server 124.

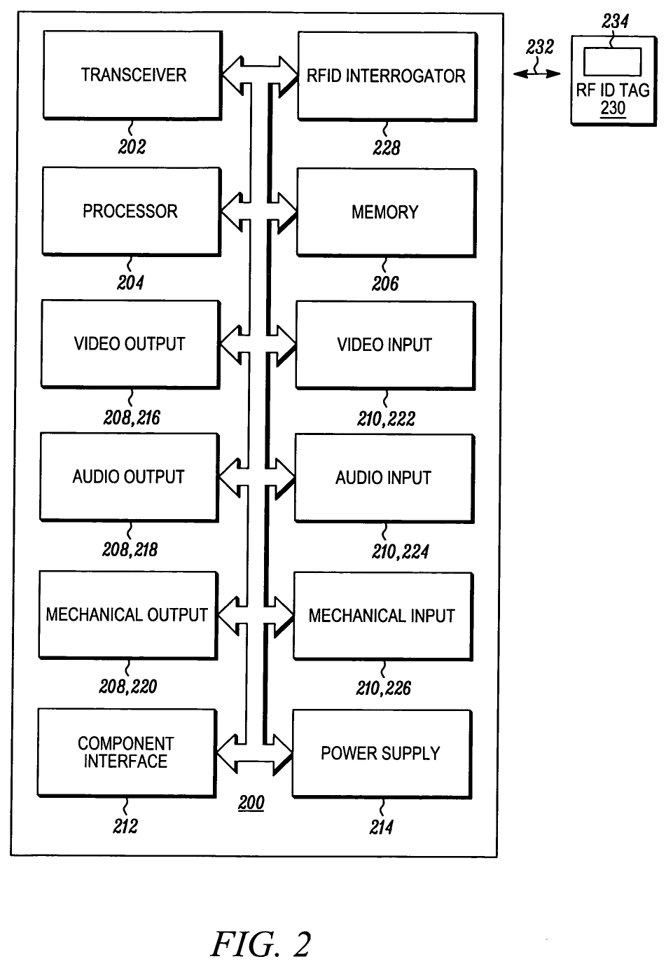

Referring to FIG. 2, there is provided a block diagram illustrating exemplary internal components 200 of the mobile device 102 in accordance with the present invention. The exemplary embodiment includes one or more wireless transceivers 202, a processor 204, a memory portion 206, one or more output devices 208, and one or more input devices 210. Each embodiment may include a user interface that comprises one or more output devices 208 and one or more input device 210. Each transceiver 202 may utilize wireless technology for communication, such as the wireless communication links or connections described above. The internal components 200 may further include a component interface 212 to provide a direct connection to auxiliary components or accessories for additional or enhanced functionality. The internal components 200 preferably include a power supply 214, such as a battery, for providing power to the other internal components while enabling the mobile device 102 to be portable.

The input and output devices 208, 210 of the internal components 200 may include a variety of video, audio and/or mechanical outputs. For example, the output device(s) 208 may include a video output device 216 such as a liquid crystal display and light emitting diode indicator, an audio output device 218 such as a speaker, alarm and/or buzzer, and/or a mechanical output device 220 such as a vibrating mechanism. Likewise, by example, the input devices 210 may include a video input device 222 such as an optical sensor (for example, a camera), an audio input device 224 such as a microphone, and a mechanical input device 226 such as a flip sensor, keyboard, keypad, selection button, touch pad, touch screen, capacitive sensor, motion sensor, and switch. Actions that may actuate one or more input devices 210 include, but not limited to, opening the wireless communication device, unlocking the device, moving the device to actuate a motion, moving the device to actuate a location positioning system, and operating the device.

The memory portion 206 of the internal components 200 may be used by the processor 204 to store and retrieve data. The data that may be stored by the memory portion 206 include, but is not limited to, operating systems, applications, and data. Each operating system includes executable code that controls basic functions of the communication device, such as interaction among the components of the internal components 200, communication with external devices via the transceiver 202 and/or the component interface 212, and storage and retrieval of applications and data to and from the memory portion 206. Each application includes executable code utilizes an operating system to provide more specific functionality for the communication device. Data is non-executable code or information that may be referenced and/or manipulated by an operating system or application for performing functions of the communication device. An example of data stored by the memory portion 206 includes a restriction table that includes one or more functions of the mobile device 102 that may be restricted in response to receiving an incoming electromagnetic wave signal from an RFID tag.

It is to be understood that FIG. 2 is for illustrative purposes only and is for illustrating components of a mobile device in accordance with the present invention, and is not intended to be a complete schematic diagram of the various components required for a mobile device. Therefore, a mobile device may include various other components not shown in FIG. 2 and still be within the scope of the present invention.

In addition to the transceiver or transceivers 202, the internal components 200 of the mobile device 102 also include an RFID reader or RFID Interrogator 228 for communicating with one or more RFID tags 230 via an RFID air interface 232. The RFID Interrogator 228 and each RFID tag 230 include an internal antenna. Each RFID tag 230 further includes an RFID circuit 234 coupled to the antenna. The antenna of the RFID tag 230 is tuned to the electromagnetic wave signals transmitted by the RFID Interrogator 228. The RFID circuit 234 sends an incoming, modulated electromagnetic wave signal to the RFID Interrogator in response to receiving the outgoing electromagnetic wave signal from the RFID Interrogator.

The RFID tag 230 may be passive or active. Passive RFID tags do not have their own power supply and, so, they draw power from fields created by the RFID Interrogator 228. The electrical current induced in the antenna of the RFID tag 230 by the incoming radio frequency scan of the RFID Interrogator 228 provides enough power for the RFID tag 230 to send a response. Active RFID tags, on the other hand, must have a power source, and may have longer ranges and larger memories than passive tags, as well as the ability to store additional information sent by the RFID Interrogator 228. The RFID tag 230 includes an ID number, for example, a GUID, and may also include other information such as a restriction command associated with one or more functions of the mobile device 102.

A user of the mobile device 102 may activate the RFID Interrogator 228 by activating, for example, a button which is part of the input devices 210. Any suitable user activation of the RFID Interrogator 228 may be used without diverting from the scope of the present invention.

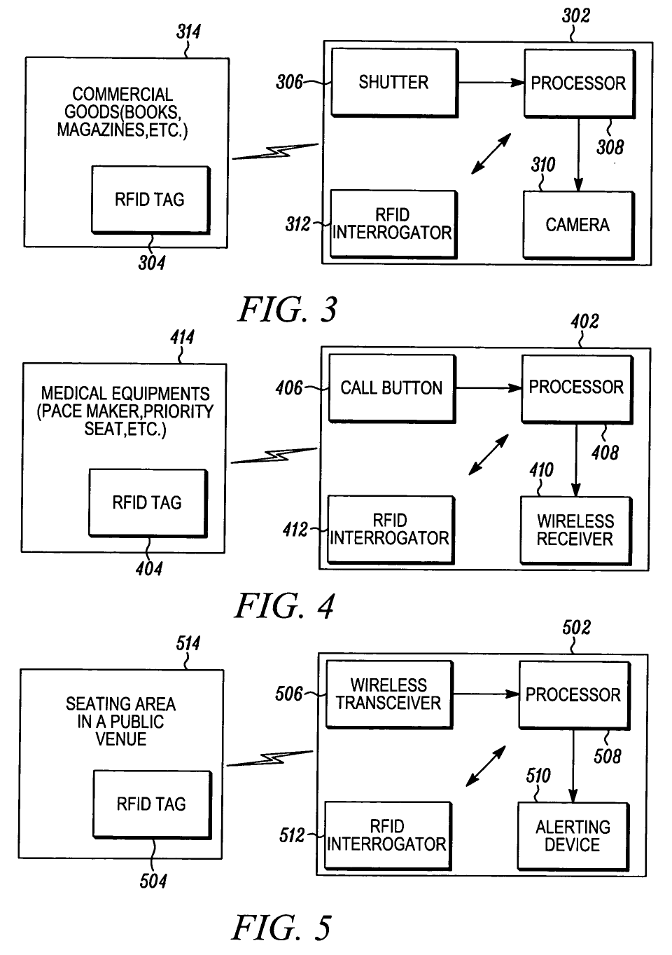

Referring to FIG. 3, there is shown a mobile device 302 in communication with an RFID tag 304. For this embodiment, operation of a video and/or audio device of the mobile device may be restricted to avoid digital shoplifting of video, audio or multimedia content. When an activation switch, for example a shutter button 306, of the mobile device 302 is activated, a processor 308 of the mobile device determines that an event associated with a video and/or audio device 310 has been initiated by a user of the mobile device. As a result, the processor 308 instructs an RFID Interrogator 312 to scan for any RFID tags within detection range of the RFID Interrogator and acquire available information from one or more of the discovered RFID tags. Upon receiving this instruction from the processor 308, the RFID Interrogator 312 emits an RFID electromagnetic wave signal to scan for RFID tags within the vicinity of the mobile device 302. Thereafter, the RFID Interrogator 312 awaits a response in the form of another RFID electromagnetic wave signal from any RFID tags in the vicinity. Upon receiving any responses, the RFID Interrogator 312 conveys any signals received from one or more nearby RFID tags, such as RFID tag 304, to the processor 308.

The exemplary RFID tag 304, shown in FIG. 3, is attached to a commercial good 314 containing media content, such as a periodical or a book. When the processor 308 receives the signal from one or more nearby RFID tags, via the RFID Interrogator 312, the processor may identify data within the signal, such as a flag, indicating that video and/or audio capture operations are prohibited within the vicinity of the RFID tag corresponding to the signal. Thus, the processor 308 may refrain from instructing the video and/or audio device 310 to capturing any video and/or audio data, or the processor may instruct the video and/or audio device to refrain from capturing any video and/or audio data. In any case, the processor 308 and the video and/or audio device 310 may not attempt to perform any video and/or audio capture operation until the RFID Interrogator 312 provides an indication that RFID tags that prohibit video and/or audio capture operations are not within the vicinity of the mobile device 302.

If the user of the mobile device 302 receives rights to the content associated with a discovered RFID tag, such as by purchasing the commercial good that includes the RFID tag, the mobile device should be permitted to perform video and/or audio capture operations in the vicinity of the commercial good. It may be necessary for the mobile device 302 to move out of range of other RFID tags prohibiting video and/or audio capture operations, but operation the video and/or audio device 310 of the mobile device should not be hindered by the RFID in which rights have been obtained. Accordingly, the RFID tag, such as the RFID circuit of the RFID tag, may be nullified or the processor 308 may reference a table that tracks permissions associated with each RFID tag, so that the video and/or audio device 310 may perform capture operations without hindrance by the RFID tag.

Referring to FIG. 4, there is shown a mobile device 402 in communication with another type of RFID tag 404. For this embodiment, the electromagnetic emissions of the mobile device 402 may be restricted to avoid causing malfunctions in nearby medical equipment, such as pacemakers. When an activation switch, for example a call button 406, of the mobile device 402 is activated, a processor 408 of the mobile device determines that an event associated with a wireless communication transceiver 410 (such as transceiver 202 shown in FIG. 2) has been initiated by a user of the mobile device. As a result, the processor 408 instructs an RFID Interrogator 412 to scan for any RFID tags within detection range of the RFID Interrogator and acquire available information from one or more of the discovered RFID tags. Upon receiving this instruction from the processor 408, the RFID Interrogator 412 emits an RFID electromagnetic wave signal to scan for RFID tags within the vicinity of the mobile device 402. Thereafter, the RFID Interrogator 412 awaits a response in the form of another RFID electromagnetic wave signal from any RFID tags in the vicinity. Upon receiving any responses, the RFID Interrogator 412 conveys any signals received from one or more nearby RFID tags, such as RFID tag 404, to the processor 408.

The exemplary RFID tag 404, shown in FIG. 4, is attached to a medical device or equipment having radio frequency sensitive circuitry, such as a pace maker or a priority medical seat. Any effect of RFID Interrogator 412 on the medical device or equipment would be minimal since the RFID Interrogator is a low-power, short range transponder, but higher powered and/or longer range transponders, such as devices that emit wireless cellular signals to base stations or access points, may have significant impact on the operation of the medical device or equipment. When the processor 408 receives the signal from one or more nearby RFID tags, via the RFID Interrogator 412, the processor may identify data within the signal, such as a flag, indicating that operation of the wireless transceiver 410 is prohibited within the vicinity of the RFID tag corresponding to the signal. Thus, the processor 408 may refrain from instructing the wireless transceiver 410 to transmit communication signals, or the processor may instruct the wireless transceiver to refrain from transmitting communication signals. In any case, the processor 408 and the wireless transceiver 410 may not attempt to perform any wireless communication operation until the RFID Interrogator 412 provides an indication that RFID tags that prohibit wireless communication operations are not within the vicinity of the mobile device 402.

Referring to FIG. 5, there is shown a mobile device 502 in communication with yet another type of RFID tag 504. For this embodiment, operation of the mobile device may be restricted to void the social annoyances at venues, such as concert halls, libraries and public transportation vehicles. When a wireless transceiver, for example a wireless cellular transceiver 506, of the mobile device 502 detects and/or receives an incoming call, a processor 508 of the mobile device determines that an event associated with a call or an alerting device 510 (such as output device(s) 208 shown in FIG. 2) has been initiated by a user of the mobile device. As a result, the processor 408 instructs an RFID Interrogator 512 to scan for any RFID tags within detection range of the RFID Interrogator and acquire available information from one or more of the discovered RFID tags. Upon receiving this instruction from the processor 508, the RFID Interrogator 512 emits an RFID electromagnetic wave signal to scan for RFID tags within the vicinity of the mobile device 502. Thereafter, the RFID Interrogator 512 awaits a response in the form of another RFID electromagnetic wave signal from any RFID tags in the vicinity. Upon receiving any responses, the RFID Interrogator 512 conveys any signals received from one or more nearby RFID tags, such as RFID tag 504, to the processor 508.

The exemplary RFID tag 504, shown in FIG. 5, is attached to a seating area of the public venue, such as each seat in the seating area. When the processor 508 receives the signal from one or more nearby RFID tags, via the RFID Interrogator 512, the processor may identify data within the signal, such as a flag, indicating that visual and/or audio alerts are prohibited within the vicinity of the RFID tag corresponding to the signal. Thus, the processor 508 may refrain from instructing the alerting device 510 to emit any visual and/or audio alerts, or the processor may instruct the alerting device to refrain from emitting any visual and/or audio alerts. In any case, the processor 508 and the alerting device 510 may not attempt to perform any alerting operation until the RFID Interrogator 512 provides an indication that RFID tags that prohibit visual and/or audio alerts are not within the vicinity of the mobile device 502.

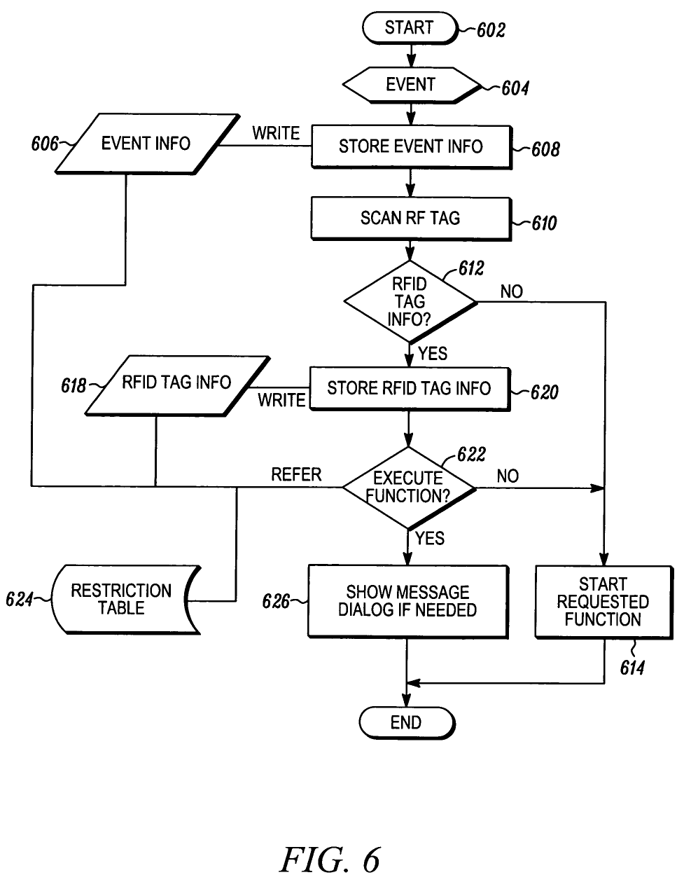

Referring to FIG. 6, there is shown a process flow chart representing an exemplary operation 600 of the mobile device 102 that is substantially common to all embodiments described above. After initiating the exemplary operation 600 at step 602, the mobile device 102 detects that an event has occurred at step 602. As described above, the event may be a variety of different actuations, such as activation of an activation switch or detection of an incoming call. The mobile station 102 then stores the event as event information 606 in the memory portion 206 at step 608, so that it may be utilized for subsequent steps as described below. Next, the mobile station 102 scans for RFID tags within its vicinity by sending an RFID electromagnetic wave signal within its transmission range and awaiting a response from any RFID tag nearby at step 610.

After scanning for RFID tags, the mobile device 102 determines whether any RFID tags have been discovered at step 612. If the mobile device 102 does not receive any responses to its RFID electromagnetic wave signal, then the mobile station determines that there are no RFID tags nearby, proceeds with the operation associated with the event at step 614, and the exemplary operation terminates at step 616. If, on the other hand, the mobile device 102 receives one or more responses to its RFID electromagnetic wave signal, then the mobile device determines that at least one RFID tag exists nearby and stores the information 618 received from each RFID tag in the memory portion 206 at step 620, so that it may be utilized for subsequent steps as described below.

After the mobile device 102 receives the RFID tag information 618, the mobile device determines whether the event initiated at step 604 is restricted by the RFID tag information at step 622. For one embodiment, the mobile device looks-up the RFID tag information 618 in a restriction table 624 and determines whether the event information 606 in the restriction table matches with events associated with the RFID tag information. For this embodiment, if the event information 606 in the restriction table matches with events associated with the RFID tag information, then the event is restricted; otherwise, the mobile device may proceed. In any case, if the mobile device 102 determines that the event is not restricted, then the mobile device 102 may proceed with the operation associated with the event at step 614, and the exemplary operation terminates at step 616. If, on the other hand, the mobile device 102 determines that the event is restricted, then the mobile device may not proceed with the operation associated with the event and the exemplary operation terminates at step 616. Optionally, a message dialog may be presented by the mobile device, such as the output device(s) 208 of FIG. 2, to inform the user of the mobile device that the requested function is restricted or otherwise cannot be performed.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A mobile device comprising:
a wireless communication transceiver configured to communicate with a remote wireless station;
a radio frequency identification reader configured to transmit an outgoing signal to a radio frequency identification tag and receive an incoming electromagnetic wave signal in response to the outgoing electromagnetic wave signal, the incoming electromagnetic wave signal including an identification number associated with the radio frequency identification tag; and
a processor configured to manage operation of the wireless communication transceiver and the radio frequency identification reader and restrict operation of a function associated with the incoming electromagnetic wave signal in response to determining that the radio frequency identification reader has received the incoming electromagnetic wave signal.

2. The mobile device of claim 1, wherein:
the function of the mobile device is operation of the wireless communication transceiver; and
the processor restricts operation of the wireless communication transceiver in response to determining that the radio frequency identification reader has received the incoming electromagnetic wave signal.

3. The mobile device of claim 2, wherein the identification number of the incoming electromagnetic wave signal is associated with medical equipment.

4. The mobile device of claim 2, wherein the identification number of the incoming electromagnetic wave signal is associated with a seating area of a theatrical forum.

5. The mobile device of claim 1, further comprising a video input device, wherein:
the function of the mobile device is operation of the video input device; and
restricts operation of the video input device in response to determining that the radio frequency identification reader has received the incoming electromagnetic wave signal.

6. The mobile device of claim 5, wherein the identification number of the incoming electromagnetic wave signal is associated with a commercial good.

7. The mobile device of claim 1, further comprising a restriction table including at least one function of the mobile device that may be restricted in response to receiving the incoming electromagnetic wave signal.

8. The mobile device of claim 7, wherein the processor identifies the at least one function to be restricted in response to receiving the incoming electromagnetic wave signal by looking-up a restriction function corresponding to the identification number in the restriction table of the mobile device.

9. The mobile device of claim 7, wherein the incoming electromagnetic wave signal further includes a restriction command associated with the function of the mobile device.

10. The mobile device of claim 9, wherein the processor identifies the at least one function to be restricted in response to receiving the incoming electromagnetic wave signal by looking-up a restriction function corresponding to the restriction command in the restriction table of the mobile device.

11. A method of a mobile device having a wireless communication transceiver and a radio frequency identification reader, the method comprising:
transmitting an outgoing electromagnetic wave signal to a radio frequency identification tag;
receiving an incoming electromagnetic wave signal in response to the outgoing electromagnetic wave signal, the incoming electromagnetic wave signal including an identification number associated with the radio frequency identification tag; and
restricting operation of a function associated with the incoming electromagnetic wave signal in response to determining that the radio frequency identification reader has received the incoming electromagnetic wave signal.

12. The method of claim 11, wherein restricting operation of a function associated with the incoming electromagnetic wave signal includes restricting operation of the wireless communication transceiver in response to determining that the radio frequency identification reader has received the incoming electromagnetic wave signal.

13. The method of claim 12, wherein the identification number of the incoming electromagnetic wave signal is associated with medical equipment.

14. The method of claim 2, wherein the identification number of the incoming electromagnetic wave signal is associated with a seating area of a theatrical forum.

15. The method of claim 1, restricting operation of a function associated with the incoming electromagnetic wave signal includes restricting operation of a video input device of the mobile device in response to determining that the radio frequency identification reader has received the incoming electromagnetic wave signal.

16. The method of claim 15, wherein the identification number of the incoming electromagnetic wave signal is associated with a commercial good.

17. The method of claim 1, further comprising identifying at least one function to be restricted in response to receiving the incoming electromagnetic wave signal.

18. The method of claim 17, wherein identifying at least one function to be restricted in response to receiving the incoming electromagnetic wave signal includes looking-up a restriction function corresponding to the identification number in the restriction table of the mobile device.

19. The method of claim 17, wherein receiving an incoming electromagnetic wave signal in response to the outgoing electromagnetic wave signal includes receiving a restriction command associated with the function of the mobile device.

20. The method of claim 19, wherein identifying at least one function to be restricted in response to receiving the incoming electromagnetic wave signal includes looking-up a restriction function corresponding to the restriction command in the restriction table of the mobile device.
